(19) United States
(12) Patent Application Publication
(10) Pub. No.: US 2015/0020902 A1
(43) Pub. Date: Jan. 22, 2015

(54) COUPLER FOR A DISHWASHER

(71) Applicant: JOHNSON ELECTRIC S.A., Murten (CH)

(72) Inventors: Min LI, Shenzhen (CN); Xiao Lin ZHANG, Shenzhen (CN); Moola Mallikarjuna REDDY, Hong Kong (CN)

(21) Appl. No.: 14/336,277

(22) Filed: Jul. 21, 2014

(30) Foreign Application Priority Data
Jul. 22, 2013 (CN) 201320437664.5

(51) Int. Cl. A47L 15/42; F16L 21/00

(52) U.S. Cl. CPC A47L 15/4217; F16L 21/005; A47L 15/4225
USPC 137/565.01; 285/417

(57) ABSTRACT

A dishwasher has a sump for collecting water. A discharge pipe leads from the sump. A pump for removing water from the sump is mounted within the dishwasher. An inlet pipe leads to the pump. A pipe coupler couples the discharge pipe to the inlet pipe. The coupler has a middle portion having a middle internal diameter; a first end portion disposed at a first end of the middle portion and arranged to receive an end of the discharge pipe; and a second end portion disposed at a second end of the middle portion and arranged to receive an end of the inlet pipe. The middle internal diameter is adapted to provide a smooth transition between an internal diameter of the discharge pipe and an internal diameter of the inlet pipe.

### CROSS REFERENCE TO RELATED APPLICATIONS

This non-provisional patent application claims priority under 35 U.S.C. §119(a) from Patent Application No. 201320437664.5 filed in The People's Republic of China on Jul. 22, 2013, the entire contents of which are hereby incorporated by reference.

### FIELD OF THE INVENTION

This invention relates to a pipe coupler and in particular, to a pipe coupler for use in a dishwasher.

### BACKGROUND OF THE INVENTION

Due to an increasing consideration on energy consumption, energy utilization rate of a mechanical device acquires more and more focus from the whole society.

Dishwashers are used widely in domestic and commercial applications. Inside the dishwasher a sump collects the water for recirculation or removal at the end of a washing cycle. After cleaning, the waste water is pumped out by a drain pump. The sumps and drain pumps are manufactured individually. An inlet pipe is provided on the drain pump and a discharge pipe is provided on the sump. The inlet pipe and the discharge pipe are connected by a pipe coupler which forms a significant part of the flow path for the water flowing from the sump to the drain pump. The drain pump is operated to drain the sump and the water flows into the discharge pipe, through the pipe coupler, through the inlet pipe and into the pump to be removed from the dishwasher.

FIG. 1 illustrates the flow of water in a prior art dishwasher. During discharge, water flows through discharge pipe 10, pipe coupler 5 and inlet pipe 20 to reach the pump. Pipe coupler 5 is typically a rubber tube that covers ends of discharge pipe 10 and inlet pipe 20. Thus, because the internal diameter of pipe coupler 5 is bigger than the internal diameters of discharge pipe 10 and inlet pipe 20, turbulence is created at the location near the internal wall of the pipe coupler, causing air-liquid separation. Air is also trapped in this space formed by the sudden change in the diameter of the flow path. This leads to energy loss in the flow of the water and hence requires more time to remove the water.

### SUMMARY OF THE INVENTION

Hence there is a desire for a pipe coupler which provides a smooth transition between the discharge pipe and the inlet pipe to increase the efficiency of the operation of the drain pump.

Accordingly, in one aspect thereof, the present invention provides a pipe coupler for connecting a first pipe having an internal diameter to a second pipe having an internal diameter, the coupler comprising: a middle portion having a middle internal diameter; a first end portion disposed at a first end of the middle portion and arranged to receive an end of the first pipe; and a second end portion disposed at a second end of the middle portion and arranged to receive an end of the second pipe, wherein the middle internal diameter is adapted to provide a smooth transition between the internal diameter of the first pipe and the internal diameter of the second pipe.

Preferably, the first pipe, the second pipe and the middle portion all have the same internal diameter and an inner surface of the middle portion forms a right cylindrical surface.

Alternatively, the internal diameter of the second pipe is greater than the internal diameter of the first pipe and the internal diameter of the middle portion varies smoothly from the first end to the second end.

Preferably, an inner surface of the middle portion forms a part conical surface.

Preferably, the coupler is formed of a resiliently deformable material.

According to a second aspect, the present invention provides a dishwasher comprising: a sump for collecting water; a discharge pipe leading from the sump and having a first internal diameter; a pump for removing water from the sump; an inlet pipe leading to the pump and having a second internal diameter; and a pipe coupler, coupling the discharge pipe to the inlet pipe, wherein the coupler comprising: a middle portion having a middle internal diameter; a first end portion disposed at a first end of the middle portion and arranged to receive an end of the discharge pipe; and a second end portion disposed at a second end of the middle portion and arranged to receive an end of the inlet pipe, wherein the middle internal diameter is adapted to provide a smooth transition between the internal diameter of the discharge pipe and the internal diameter of the inlet pipe.

Preferably, the coupler forms a significant portion of the water flow path between the sump and the pump.

Preferably, the middle portion of the coupler provides a smooth transition between the discharge pipe and the inlet pipe.

Preferably, the coupler is formed of a resiliently deformable material.

Preferably, the internal diameter of the discharge pipe is not the same as the internal diameter of the inlet pipe and the internal diameter of the middle portion smoothly varies from being equal to the internal diameter of the discharge pipe at the first end to being equal to the internal diameter of the inlet pipe at the second end.

Preferably, an inner surface of the middle portion is part conical.

Alternatively, the discharge pipe, the inlet pipe and the middle portion all have the same internal diameter and an inner surface of the middle portion forms a right cylindrical surface.

The pipe coupler of the present invention provides reliable water removal with less energy loss due to a reduction of turbulence and air trapped within the coupler. Less turbulence and less trapped air leads to an improvement in the hydraulic efficiency of the discharge mechanism and faster removal of the water. Thus the overall operating time of the dishwasher is reduced, saving on energy costs.

### BRIEF DESCRIPTION OF THE DRAWINGS

A preferred embodiment of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 illustrates a prior art pipe coupler;

FIG. 2 is a view of a pipe coupler in accordance with a first preferred embodiment of the present invention;

FIG. 3 is a sectional view of the pipe coupler of FIG. 2;

FIG. 4 is a sectional view of the pipe coupler of FIG. 2, fitted to a discharge pipe and an inlet pipe;

FIG. 5 illustrates the pipe coupler of FIG. 4;

FIG. 6 is a sectional view of a pipe coupler according to another preferred embodiment of the present invention; and

FIG. 7 is a schematic view of a dishwasher incorporating a pipe coupler according to the present invention.

### DETAILED DESCRIPTION OF THE PREFERRED EMBODIMENTS

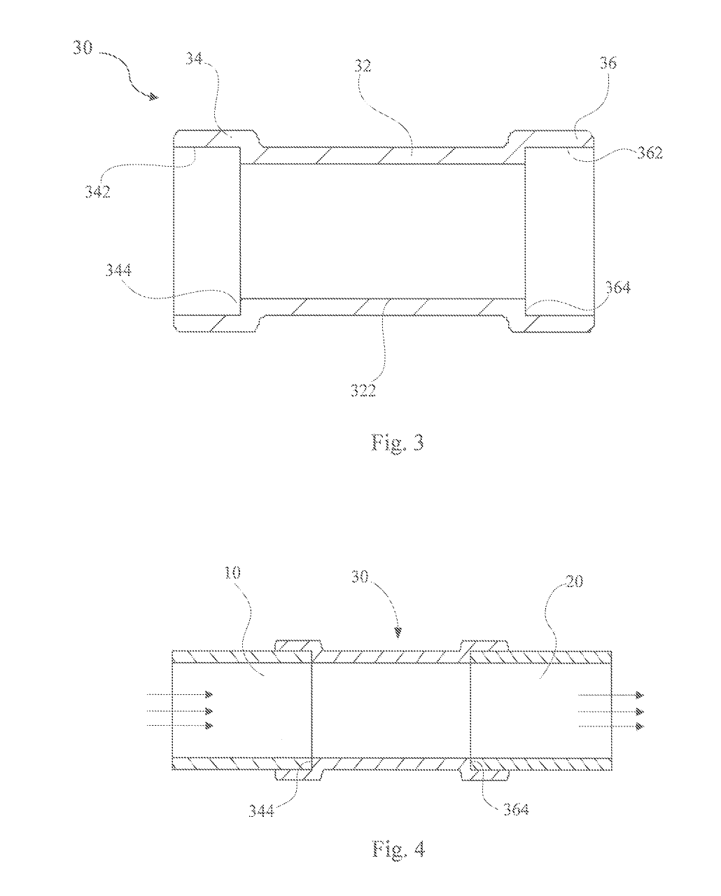

FIGS. 2 and 3 illustrate a pipe coupler 30 in accordance with the preferred embodiment of the present invention. It should be noted that FIGS. 2 and 3 show only those elements of pipe coupler 30 necessary for the description of the structure. By way of example, fastening members, such as a ring clamp, may be used to secure the pipe coupler to the discharge pipe and inlet pipe.

Pipe coupler 30 comprises a middle portion 32, a first end portion 34 disposed at a first end of the middle portion and a second end portion 36 disposed at a second end of the middle portion. The internal diameter of middle portion 32 is smaller than the internal diameters of first end portion 34 and second end portion 36. Preferably, the shape of first end portion 34 and second end portion 36 are similar or same. In accordance with this embodiment, a first radial step 344 is formed at the boundary between an internal wall 342 of first end portion 34 and an internal wall 322 of middle portion 32, and a second radial step 364 is formed at the boundary between an internal wall 362 of second end portion 36 and internal wall 322 of middle portion 32. Both first step 344 and second step 364 are annular shapes.

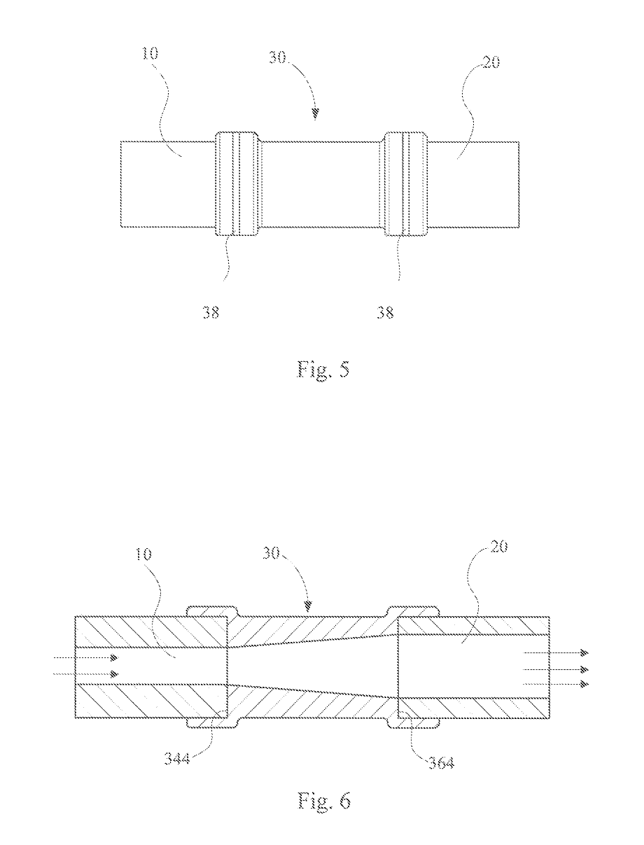

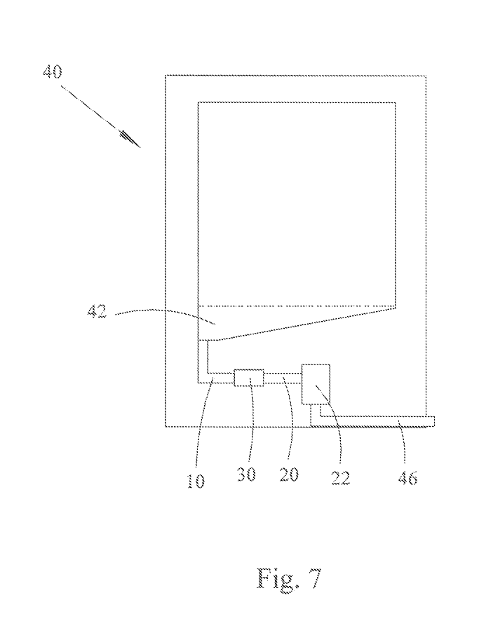

FIG. 4 is a sectional view of pipe coupler 30 fitted to a discharge pipe 10 and an inlet pipe 20. FIG. 5 is a solid view of the arrangement of FIG. 4. Discharge pipe 10, extending from a sump 42 of a dishwasher 40 (shown in FIG. 7), is connected with first end portion 34 of pipe coupler 30, and inlet pipe 20 lead to a water pump 22 (shown in FIG. 7) is connected with second end portion 36 of pipe coupler 30. The axial end of discharge pipe 10 is pressed against first step 344 of pipe coupler 30. The axial end of inlet pipe 20 is pressed against second step 364 of pipe coupler 30. The height of first step 344 is substantially equal to the wall thickness of discharge pipe 10, and the height of second radial step 364 is substantially equal to the wall thickness of inlet pipe 20, with the discharge pipe and the inlet pipe being a press fit within the respective end portion. in other words, discharge pipe 10, inlet pipe 20 and pipe coupler 30 together form a passageway with a constant internal diameter. Thus, water flows along the passageway as indicated by the arrows in FIG. 4, so as to avoid generation of turbulence or eddies, and also to avoid air-liquid separation. Thus the efficiency of the drain pump is improved. In the meantime, operating time of the water pump is reduced, which also improves the overall efficiency of the dishwasher.

In case pipe coupler 30 is made of rubber material or other resiliently deformable material, first end portion 34 and second end portion 36 may be connected to the ends of discharge pipe 10 and inlet pipe 20 by various fastening methods. Preferably, the end portions are stretched over the ends to provide a resilient connection which may be reinforced by various fasteners, as generally indicated by 38 in FIG. 5, including ring clamps and wire clamps. If discharge pipe 10, inlet pipe 20 and pipe coupler 30 are made of a thermoplastic material, hot lamination technology or adhesives may be used to connect them. In other embodiments, discharge pipe 10 and inlet pipe 20 may be connected with pipe coupler 30 by screw joints.

In the first embodiment, internal diameters of discharge pipe 10 and inlet pipe 20 are substantially same so as to achieve the best draining efficiency with the internal surface of the middle portion forming a right cylindrical surface. FIG. 6 illustrates a second embodiment in which the internal diameters of discharge pipe 10 and inlet pipe 20 are different. In this situation, the internal diameter of pipe coupler 30 is gradually varied from one diameter to the other so as to match the internal diameter of the corresponding end to avoid any abrupt change in the diameter of the flow path between the discharge pipe and the coupler, between the coupler and the inlet pipe or along the middle portion of the coupler, i.e., the internal diameter of pipe coupler 30 may be part conical in shape. The internal diameter of the middle portion smoothly changes from the internal diameter at first step 344 to the internal diameter of second radial step 364, so as to reduce or avoid creating turbulence as the water flows through the coupler. It will be noted that the length of the flow path through the middle portion of the coupler is significant for the generation of turbulence. This length provides a degree of isolation of the pump from the sump, especially where the coupler is made of resiliently deformable material, isolating the sump from the vibrations of the pump and this reducing the noise of the dishwasher during the operation of the pump,

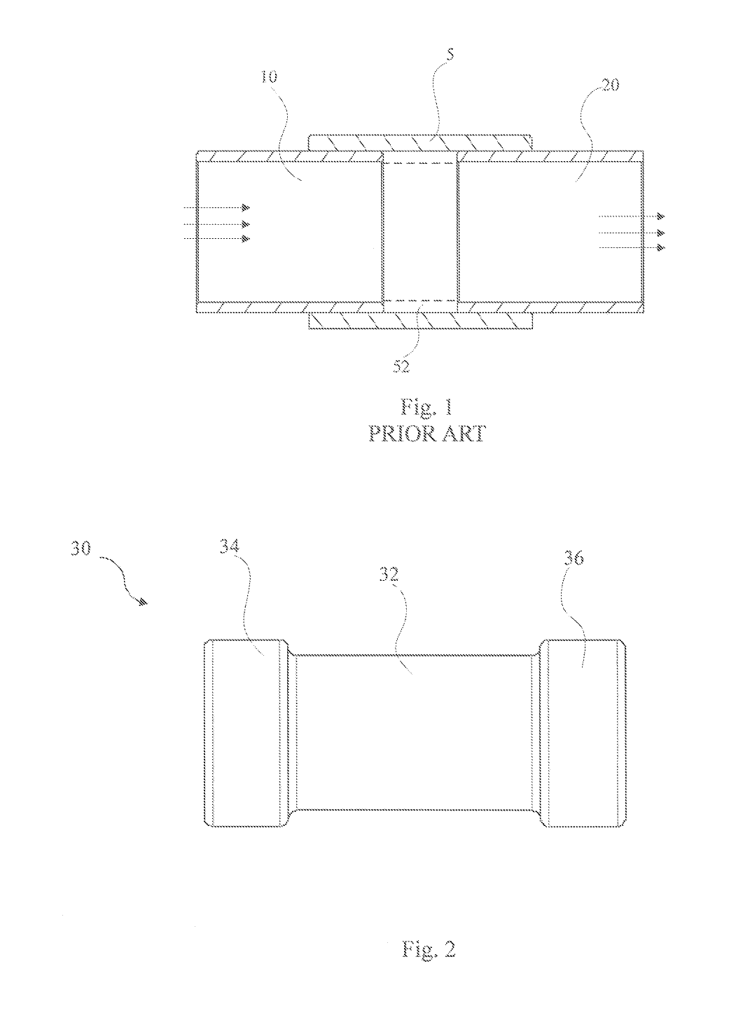

Through experimentation, water pumped using the prior art pipe coupler of FIG. 1 includes some air for approximately 30 seconds when the pump starts, which leads to a low draining efficiency. However, using a pipe coupler in accordance with the present invention entrained air occurs for only 5 seconds when the pump starts. Thus the hydraulic efficiency is increased and the operating time of the pump is reduced.

FIG. 7 is a schematic diagram of a dishwasher 40 incorporating a pipe coupler 30 according to the present invention. The dishwasher has a sump 42 in which the water collects. During discharge or removal of water from the dishwasher, water in the sump flows through the discharge pipe 10, coupler 30 and inlet pipe 20 to reach the pump 22 and then pumped out of the dishwasher through hose 46.

In the description and claims of the present application, each of the verbs “comprise”, “include”, “contain” and “have”, and variations thereof, are used in an inclusive sense, to specify the presence of the stated item or feature but do not preclude the presence of additional items or features.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of examples only, and various other modifications will be apparent to persons skilled in the field without departing from the scope of the invention as defined by the appended claims.

1. A pipe coupler for connecting a first pipe having an internal diameter to a second pipe having an internal diameter, the coupler comprising:
a middle portion having a middle internal diameter;
a first end portion disposed at a first end of the middle portion and arranged to receive an end of the first pipe; and
a second end portion disposed at a second end of the middle portion and arranged to receive an end of the second pipe,
wherein the middle internal diameter is adapted to provide a smooth transition between the internal diameter of the first pipe and the internal diameter of the second pipe.

2. The coupler of claim 1, wherein the first pipe, the second pipe and the middle portion all have the same internal diameter and an inner surface of the middle portion forms a right cylindrical surface,

3. The coupler of claim 1, wherein the internal diameter of the second pipe is greater than the internal diameter of the first pipe and the internal diameter of the middle portion varies smoothly from the first end to the second end.

4. The coupler of claim 3, wherein an inner surface of the middle portion forms a part conical surface.

5. The coupler of claim 1, wherein the coupler is formed of a resiliently deformable material.

6. A dishwasher comprising:
a sump for collecting water;
a discharge pipe leading from the sump and having a first internal diameter;
a pump for removing water from the sump;
an inlet pipe leading to the pump and having a second internal diameter; and
a pipe coupler, coupling the discharge pipe to the inlet pipe,
wherein the coupler comprising:
a middle portion having a middle internal diameter;
a first end portion disposed at a first end of the middle portion and arranged to receive an end of the discharge pipe; and
a second end portion disposed at a second end of the middle portion and arranged to receive an end of the inlet pipe,
wherein the middle internal diameter is adapted to provide a smooth transition between the internal diameter of the discharge pipe and the internal diameter of the inlet pipe.

7. The dishwasher of claim 6, wherein the coupler forms a significant portion of the water flow path between the sump and the pump.

8. The dishwasher of claim 7, wherein the middle portion of the coupler provides a smooth transition between the discharge pipe and the inlet pipe.

9. The dishwasher of claim 6, wherein the coupler is formed of a resiliently deformable material.

10. The dishwasher of claim 6, wherein the internal diameter of the discharge pipe is not the same as the internal diameter of the inlet pipe and the internal diameter of the middle portion smoothly varies from being equal to the internal diameter of the discharge pipe at the first end to being equal to the internal diameter of the inlet pipe at the second end.

11. The dishwasher of claim 10, wherein an inner surface of the middle portion is part conical.

12. The dishwasher of claim 6, wherein the discharge pipe, the inlet pipe and the middle portion all have the same internal diameter and an inner surface of the middle portion forms a right cylindrical surface,
